(19) United States
(12) Patent Application Publication
(10) Pub. No.: US 2015/0261432 A1
(43) Pub. Date: Sep. 17, 2015

(54) DISPLAY CONTROL APPARATUS AND METHOD

(71) Applicant: YAMAHA CORPORATION, Hamamatsu-shi (JP)

(72) Inventor: Tomohiro YAMAMOTO, Hamamatsu-shi (JP)

(21) Appl. No.: 14/644,999

(22) Filed: Mar. 11, 2015

(30) Foreign Application Priority Data
Mar. 12, 2014 (JP) 2014-049490

(51) Int. Cl. G06F 3/0488; G06F 3/0484

(52) U.S. Cl. CPC G06F 3/04886; G06F 3/04847; G06F 3/04842; G06F 3/04883

(57) ABSTRACT

Each of first and second types of swipe operation, different from each other, performed by a user on a touch panel associated with a display panel, can be detected. An area on a user interface screen displayed on the display panel, where the first type of swipe operation is valid, is predefined. When the first type of swipe operation is detected in the predefined area on a first user interface screen which is identified by a combination of a first operation target and a first group of operation elements, the user interface screen is changed to a second user interface screen which is identified by a combination of the first operation target and a second group of operation elements. When the second type of swipe operation is detected on the first or second user interface screen, the user interface screen is changed to a third user interface screen.

### BACKGROUND

The invention relates to a display control apparatus that includes a display device capable of detecting a swipe operation performed by user's fingers on a display screen, and relates to a display control apparatus that is favorably applied to a device for processing an audio signal such as an audio mixer.

Conventionally, a mixer that performs various types of processing such as mixing to an input audio signal and outputs the mixed signal has been known. The mixer includes plural channels for processing the audio signal, and each of the channels performs the processing of the audio signal in accordance with a parameter that is set for each of the channels. A parameter value for each of the channels has been set in such a mode that, for example, a specified selection switch is pressed to select the channel as an operation target, a selected channel screen regarding the channel is shown on a display, and a knob type control or the like on an operation panel that corresponds to a displayed object (i.e., image) of a knob on the selected channel screen is operated. For instance, in “DIGITAL MIXING CONSOLE M7CL, Owner's Manual, 2005, published by Yamaha Corporation) (hereinafter, referred to as Non-Patent Literature 1), send levels for all mixing buses are displayed on the selected channel screen. Thus, when the send level from one channel to each of the plural mixing buses is set, the knobs which respectively correspond to the mixing buses are operated to adjust the send levels (see descriptions in the “SELECTED CHANNEL section” and the “SELECTED CHANNEL VIEW screen” in Non-Patent Literature 1, for example).

Meanwhile, a personal computer with a touch panel type of a display/input section which is referred to as a tablet personal computer (PC) or the like has been known. For the tablet PC, a touch interface which allows a user to perform an operation or command an input by touching a display with a finger (or may be a touch pen or the like) is used, and the operation includes a gesture operation called a swipe operation. The swipe operation is an operation in which a finger slides on the display. The swipe operation is available as one of the user interface (UI) functions of the tablet PC, and is performed, for example, when a user command to flip or scroll a page on the screen or the like.

In a device such as the above-described mixer, various parameters of the plural channels have to be operated, and thus the UI with favorable operability is desired. Particularly, in the mixer, the parameter value is set by selecting the channel as the operation target by using the selection switch, displaying the selected channel screen, operating the knob on the operation panel which corresponds to the displayed image of the knob on the selected channel screen, and the like. Regarding a channel switching operation and a parameter setting operation which is performed after the knob to be operated is found, the improvement in operability is desired also from a perspective of prevention of erroneous operations (wrong channel selection and wrong knob operation).

### SUMMARY OF THE INVENTION

In view of the foregoing prior art problems, it is an object of the present invention to provide an improved display control apparatus in which one of plural operation targets is selected and various operation elements (parameters, for example) regarding the selected operation target is displayed in a display device, and which realizes a user interface capable of improving operationality and reducing a chance of an erroneous operation in a display control apparatus.

In order to accomplish the above-mentioned object, the present invention provides a display control apparatus which comprises: a display device configured to detect a touch operation performed by a user on a touch panel associated with a display panel, the display device being adapted to detect at least a first type of swipe operation and a second type of swipe operation different from the first type of swipe operation, and a user interface screen displayed on the display panel being identified by a combination of one of operation targets and a group of operation elements; an area setting section configured to define an area on the user interface screen displayed on the display panel where the first type of swipe operation is valid; and a display update section configured to update the user interface screen displayed on the display panel in such a manner that, (1) when the first type of swipe operation is detected in the defined area on a first user interface screen which is identified by a combination of a first operation target and a first group of operation elements, the first user interface screen is changed to a second user interface screen which is identified by a combination of the first operation target and a second group of operation elements, whereas, (2) when the second type of swipe operation is detected on the first or second user interface screen, the first or second user interface screen is changed to a third user interface screen which is identified at least by a second operation target.

In an embodiment, the first type of swipe operation and the second type of swipe operation are distinguished based on a difference in the number of fingers with which the swipe operation is performed. For example, the first type of swipe operation is a swipe operation performed with a single finger, and the second type of swipe operation is a swipe operation performed with two fingers.

In an embodiment, the display control apparatus is a display control apparatus for a mixer, the operation targets are channels for signal processing in the mixer, and the operation elements are operation elements for one of the channels which is selected as a current operation target in the mixer. Further, in the embodiment, the operation elements are send levels for a plurality of mixing buses in the mixer.

According to the present invention, when the first type of swipe operation is detected in the defined area on the first user interface screen identified by the combination of the first operation target and the first group of operation elements, the first user interface screen is changed to the second user interface screen identified by the combination of the first operation target and the second group of operation elements. On the other hand, when the second type of swipe operation is detected on the first or second user interface screen, the first or second user interface screen is changed to the third user interface screen which is identified at least by the second operation target. In this way, according to the present invention, in the display control apparatus in which one of the plural operation targets is selected and the various operation elements (the parameters, for example) regarding the selected operation target is displayed in the display device, the UI which is easily understood by a user and has favorable operability is realized, and the erroneous operations thereof can be suppressed.

The present invention may be constructed and implemented not only as the apparatus invention discussed above but also as a method invention. Also, the present invention may be arranged and implemented as a software program for execution by a processor, such as a computer or DSP, as well as a non-transitory computer-readable storage medium storing such a software program.

The following will describe embodiments of the present invention, but it should be appreciated that the present invention is not limited to the described embodiments and various modifications of the invention are possible without departing from the basic principles. The scope of the present invention is therefore to be determined solely by the appended claims.

### BRIEF DESCRIPTION OF THE DRAWINGS

Certain preferred embodiments of the present invention will hereinafter be described in detail, by way of example only, with reference to the accompanying drawings, in which:

FIG. 1 is a functional block diagram of a display control apparatus according to an embodiment of the invention;

FIG. 2 is a hardware configuration diagram of a digital mixer according to the embodiment of the invention;

FIG. 3 is a diagram showing examples of a send level setting screen;

FIG. 4 is a diagram showing examples of an effect setting screen;

FIG. 5 is a diagram showing examples of a compressor setting screen;

FIG. 6 is a flowchart of swipe event processing; and

FIG. 7 is a flowchart of a first-type-of-swipe-valid area setting processing which is performed when a kind of parameters is changed.

### DETAILED DESCRIPTION

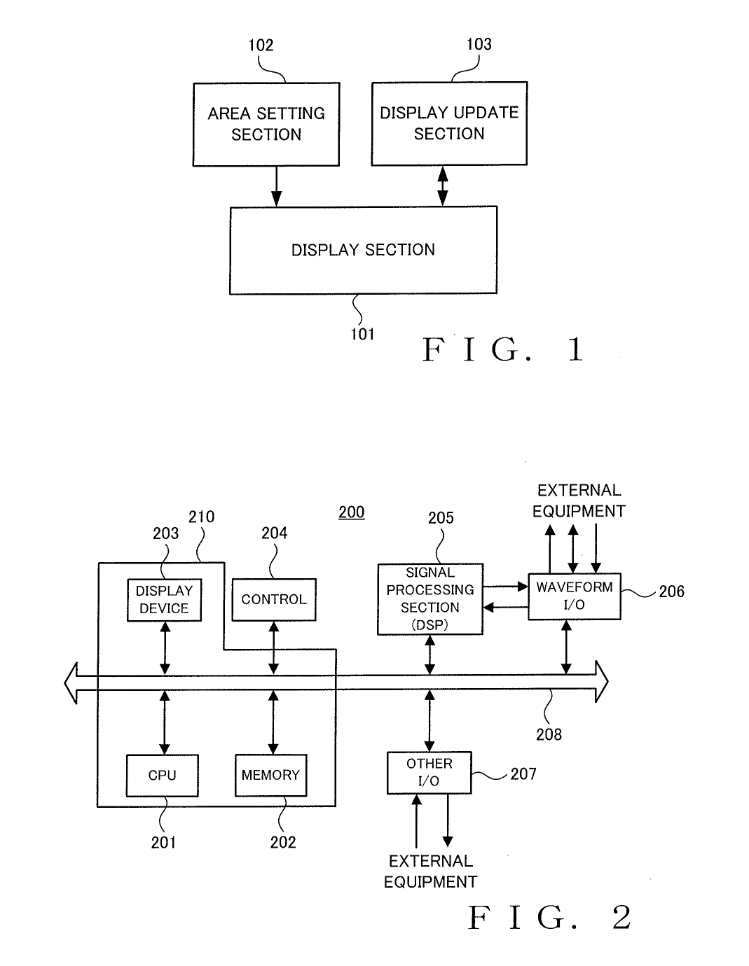

FIG. 1 is a functional block diagram of a display control apparatus according to a preferred embodiment of the invention. In the embodiment, an example in which the invention is applied to a digital mixer (an audio mixer or a video mixer, for example) will be described. However, the invention can also be applied to any apparatus which includes a display device through which one of a plurality of operation targets is selected and which displays various parameters regarding the selected operation target. The digital mixer includes a plurality of channels for processing audio signals, and each of the channels performs effect imparting processing, volume level control processing, mixing, etc. with respect to the input audio signal. Each of these channels is operated in accordance with various parameters that are set by a user. Thus, there is prepared a screen (a selected channel screen) through which one of the plurality of channels is selected and which displays the various parameters regarding the selected channel to allow the user to change settings related to the selected channel. In the embodiment, the one channel selected from among the plurality of channels is an operation target.

Of functional elements provided in the digital mixer according to the embodiment, the functional elements according to the present invention are extracted and depicted as 101 to 103 in FIG. 1. A display section 101 is configured to detect a touch operation performed by a user on a touch panel associated with a display panel, and the display section 101 is adapted to detect at least a first type of swipe operation and a second type of swipe operation different from the first type of swipe operation. A user interface (UI) screen displayed on the display panel is identified by a combination of one of “operation targets” and a group of “operation elements”. In one embodiment, the “operation targets” are channels for signal processing in the mixer, and the “operation elements” are operation elements for one channel selected as a current operation target in the mixer. An area setting section 102 is configured to set or define an area on the user interface screen displayed on the display panel of the display section 101 where the first type of swipe operation is valid. A display update section 103 is configured that, (1) when the first type of swipe operation is detected in the set area in a first user interface screen identified by a combination of a first operation target and a first group of operation elements, the first user interface screen is changed to a second user interface screen identified by a combination of the first operation target and a second group of operation elements and that, (2) when the second type of swipe operation is detected in the first or second user interface screen, the first or second user interface screen is changed to a third user interface screen identified by at least a second operation target.

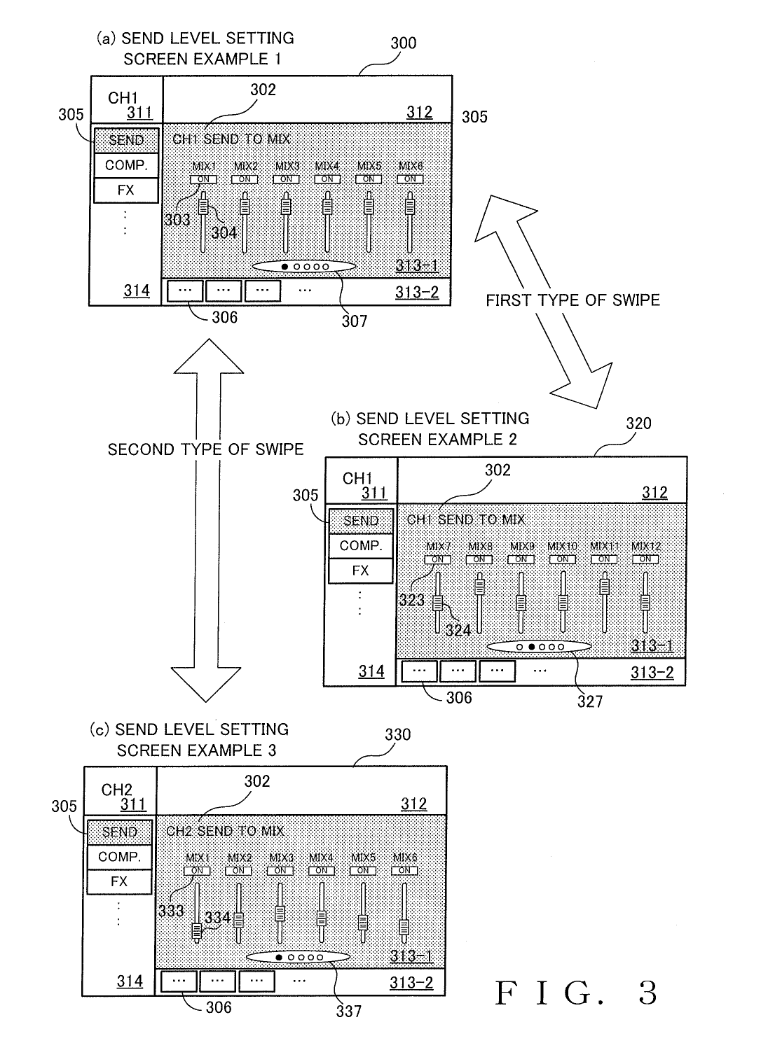

FIG. 2 is a block diagram of a main hardware configuration of a digital mixer 200 according to the embodiment of the present invention. A central processing unit (CPU) 201 is a processor which controls an operation of the entire digital mixer. A memory 202 is a storage device that stores various programs performed by the CPU 201, various data, etc., and is constructed by appropriately combining storage devices such as a RAM, a ROM, a flash memory and a hard disc. A display device 203 is mounted in an operation panel (not shown) of this mixer and displays various types of information on a display panel of the display device 203. Controls 204 are various types of control (a fader, a rotary encoder, a switch, a button, or the like) which are provided on the operation panel of this mixer and operated by the user. A signal processing section 205 is, for example, a digital signal processor (DSP), performs mixing processing, effect imparting processing, volume level control processing, etc. on audio signals input through a waveform input/output interface (I/O) 206 by executing various signal processing programs based on a command from the CPU 201, and outputs the audio signals after processing through the waveform I/O 206. The other I/O 207 is an interface for connection to various types of external equipment such as a personal computer (PC). A bus 208 is a busline for connecting each of these sections and by which a control bus, a data bus, and an address bus are collectively referred.

The display device 203 is a touch panel type of the display device which can detect a touch operation performed by a user on the touch panel associated with the display panel, and is further configured to be able to detect at least two different types of the swipe operation. In other words, the display device 203 is configured to be able to detect whether a swipe type of the touch operation performed by the user on the touch panel associated with the display panel thereof is the first type of swipe operation or the second type of swipe operation among the two types of swipe operation, either by the display device 203 itself or by cooperating with a program module (not shown) of a touch interface that can be performed by the CPU 201. In this embodiment, the first type of swipe operation is a swipe operation on the display panel by using one finger of the user, and the second type of swipe operation is a swipe operation on the display panel by using two fingers of the user. The display section 101 in FIG. 1 is realized by the display device 203 of FIG. 2. The area setting section 102 and the display update section 103 are realized by performing a predetermined program by the CPU 201 in FIG. 2. A block 210 indicates components which realize the display control apparatus according to the invention.

Substance displayed on screens, which will be described below with reference to FIG. 3 to FIG. 5, is same as substance of setting screens corresponding to conventional selected channel screens (i.e., an user interface (UI) screen for specifying an operation target channel and setting various parameters regarding the specified operation target channel). Based on a desired parameter setting instruction given by the user (any type of an instruction operation style can be used therefor), each of these setting screens (the UI screens) is displayed on the display device 203 in accordance with a display control program performed by the CPU 201. It should be noted that any screen can be used as an initial screen of the setting screen. In one example, a screen shown in a part (a) of FIG. 3 is used as the initial screen. In any of the setting screens, the second type of swipe operation is basically enabled in the entire area of the screen, and the channel as the operation target can be switched to another channel in response to the second type of swipe operation. In addition, each of the setting screens has a first-type-of-swipe-valid area unique to the setting screen. It should be noted that, on the setting screen of the mixer of the embodiment, a type of a parameter to be set for the channel as the operation target can be designated or selected by the user, and the same area of the first-type-of-swipe-valid area is defined for the screens of the same parameter type. Only when the first type of swipe operation is performed within the first-type-of-swipe-valid area, a screen control by the first type of swipe operation according to the present invention is valid. A partial screen displayed in the first-type-of-swipe-valid area can be changed by the first type of swipe operation. In this embodiment, on the displayed screen, only the area of the partial screen displayed in the first-type-of-swipe-valid area is basically changed in response to the first type of swipe operation, and display on the other part of the screen is not be changed. When the first type of swipe operation is performed in an area other than the first-type-of-swipe-valid area, the displayed screen is not changed. However, in the case where a function or the like which is related to the first type of swipe operation is defined independently in an area other than the first-type-of-swipe-valid area, an action based on a definition (for example, change of a parameter value corresponding to content displayed in the area, simple scroll of the displayed screen, or the like) may be performed in response to the first type of swipe operation in the area.

It should be noted that, in one embodiment, there is a case that all parameters regarding a operation target may not be able to be displayed at one time in the display device 203. For example, parts (a) and (b) of FIG. 3 show two examples of the screens for setting the send levels regarding a particular channel (e.g., CH1), and the examples of FIG. 3 (a), (b) show such a case that a group of controls capable of being simultaneously displayed on one screen consists of six controls, but the number of mixing buses (MX1-MX12) which can be set for the particular channel (CH1) is more than six. In the present embodiment, for sake of such the case, it is configured that operable parameters are divided into a plurality of screens and displayed thereon, wherein a single screen displayed on the display device 203 is referred to as a “page”, and switching of this screen to another screen (page) is referred to as “flipping a page” or “turning/turning back a page”. In this case, the page may be “flipped” or “turned/turned back” by a user's operation performed in a rectangular area being a part of the screen (the partial screen). Furthermore, when the screen is switched, a visual effect of physically flipping a page may be applied, or a visual effect or the like of sliding the screen may be applied so that the screen as a switching target is displayed from a lower side of the screen originally displayed.

The part (a) of FIG. 3 shows a send level setting screen example 1 (a setting screen 300). This setting screen 300 is roughly divided into four areas. An upper left area 311 is an area which displays the channel number of the current operation target channel (“CH1” shown in the figure indicates that the channel number of the current operation target channel is “1”). Area 312 on a right side thereof is an area which displays a menu, a tab, and the like for switching a function. However, because what is displayed in this area has little association with the invention, details of the area 312 are omitted. For example, this setting screen 300 as shown in part (a) of FIG. 3 can be regarded as the first user interface screen.

Area 313 on a lower side of the area 312 is an area which displays various objects (images) for setting the send level, that is, various objects for setting values of the various parameters that are included in the currently selected parameter type of the currently selected operation target channel. It should be noted that, although this area 313 is divided into upper and lower areas 313-1 and 313-2, those two areas 313-1 and 313-2 are collectively referred to as the area 313.

In the area 313-1, 302 denotes a title “CH1 SEND TO MIX” for indicating that this screen is a screen for setting send levels of a signal that is transmitted from the channel 1 (CH1) to mixing buses 1, 2, . . . (MIX1, MIX2, . . . ). 303 denotes a button for switching between ON/OFF of signal transmission from the channel 1 (CH1) to the mixing bus 1 (MIX1), and 304 denotes a fader object which indicates a signal transmission level (the send level) from the channel 1 (CH1) to the mixing bus 1 (MIX1). The fader object 304 expresses a value of the send level by a position of a knob, and the value of the send level can be changed by dragging this knob. Meanwhile, the value of the send level, which is expressed by the fader object 304, may be changed by an operation of a specific physical control provided on the operation panel. In this case, a position of the physical control is preferably synchronized with a displayed position of the fader object. Similar to the mixing bus 1 (MIX1), the ON/OFF button and the fader object are displayed for the mixing buses 2 to 6 (MIX2 to MIX6) in the area 313-1. 307 denotes a display which indicates the position of the currently displayed page in the area 313-1. A first page is shown in the part (a) of FIG. 3, and thus, in a circle on the left end of the display 307, the corresponding page is indicated by a black-marked circle. The area 313-2 is an area for displaying other buttons 306 and the like related to the send level setting. As shown in the area 313-1, the object for setting the send level is represented by an image of a fader object, that is, an image of a fader type control, for example. The six fader objects for one page being displayed in the area 313-1 constitute a group of the operation elements. For example, particular fader objects of MIX1 to MIX6 can be regarded as a first group of the operation elements.

Area 314 is an area which displays buttons, each of which specifies the parameter type set regarding the operation target channel. It is indicated that a SEND button 305 is selected (the shaded area in this part indicates that this button is selected) and that the send level setting of the channel 1 as the operation target channel is currently being performed.

The first-type-of-swipe-valid area in the screen 300 of the part (a) of FIG. 3 is the area 313-1 which is depicted as shaded area (the shaded area is to clarify the area for convenience of description, and thus is not necessarily displayed on an actual screen). When the first type of swipe operation from the right to the left is performed with respect to the depicted screen in this area 313-1, for example, processing for flipping to the next page which corresponds to this swipe operation is performed, and the display is updated from the screen example 1 in the part (a) of FIG. 3 to a screen example 2 in the part (b) of FIG. 3. In this screen example 2 (a setting screen 320), the areas 311, 312, 313-2, 314 are the same as those areas in the screen 300. The page is flipped only in the area 313-1, and a second page is displayed in the screen example 2. On the second page, ON/OFF buttons and fader objects of mixing buses 7 to 12 (MIX7 to MIX12) are displayed. Similar to the screen example 1, a reference numeral 323 is the ON/OFF button of the mixing bus 7, and a reference numeral 324 is the fader object of the mixing bus 7 (MIX7). The display is updated to the second page, and thus the display 327 of the page position is updated. For example, these fader objects of MIX7 to MIX12 can be regarded as a second group of the operation elements. In addition, for example, this setting screen 320 can be regarded as a second user interface screen.

It should be noted that, in this embodiment, even when the first type of swipe operation is performed on any of the areas 311, 312, 313-2, 314 in the part (a) of FIG. 3, the mixer does not perform display update processing of the page content display which corresponds to the operation. It is because the page display processing that corresponds to the first type of swipe operation is valid only in the area 313-1 on this screen 300 (and the same applies to 320, 330) and the other areas are not applicable to this processing. It should also be noted that, when the first type of swipe operation from the left to the right is performed with respect to the depicted screen, for example, in the area 313-1 in the part (a) of FIG. 3, a processing for flipping back to the previous page, which corresponds to this swipe operation, is performed. However, the first page is currently displayed in the area 313-1, and there is no previous page. Thus, the display is not updated. Similar to the screen 300, the area 313-1 is the first-type-of-swipe-valid area in the screen 320 in the part (b) of FIG. 3. Accordingly, by performing the first type of swipe operation from the right to the left in this area 313-1, the page can further be flipped to display the send level setting screen for a mixing bus 13 onwards. On the contrary, by performing the first type of swipe operation in a reverse direction, the page can be returned to the send level setting screen which corresponds to the mixing buses 1 to 6 ((a) of FIG. 3).

In summary, when the first type of swipe operation is detected in the area of the first user interface screen, the display update processing (the display update section 103) is configured to change the first user interface screen to the second user interface screen by replacing a partial screen corresponding to the area of the first user interface screen to another partial screen corresponding to the second group.

When the second type of swipe operation is performed at an arbitrary position on the screen in the screen 300 in the part (a) of FIG. 3, the display is updated to a screen example 3 (a setting screen 330) in the part (c) of FIG. 3. As described above, the second type of swipe operation means the operation for switching the channel as the operation target. On this screen 330, a displayed image in a area 311 is “CH2”, and thus it can be understood that the channel as the operation target is switched from the channel of the channel number 1 to a channel of the channel number 2. It should be noted that the channel number is switched to be increased by the second type of swipe operation from the right to the left on the screen and that the channel number is switched to be reduced by the second type of swipe operation from the left to the right on the screen. In the screen example 3 in the part (c) of FIG. 3, the operation target channel is switched from the screen example 1, and thus the partial screen in the area 313-1 is updated to the display of the mixing buses 1 to 6 (MIX1 to MIX6) of the channel number 2. It should be noted that, when the operation target channel is switched by the second type of swipe operation, the page position displayed in the area 313-1 (the above first page, the second page, or the like) is maintained. For example, in the case where the third page is displayed in the area 313-1 on the screen 300 and the second type of swipe operation is performed in this state, the partial screen of the third page is also displayed in the area 313-1 on the screen of the switched channel. In addition, when the screen is switched by the second type of swipe operation, the parameter type and the like regarding the displayed screen are maintained as they are. For example, when the second type of swipe operation is performed on any of the send level setting screens that are exemplified in FIG. 3, the channel as the operation target is changed or the display thereof is updated, and the screen and the setting content of the send level setting screen are maintained. For example, this setting screen 300 can be regarded as a third user interface screen.

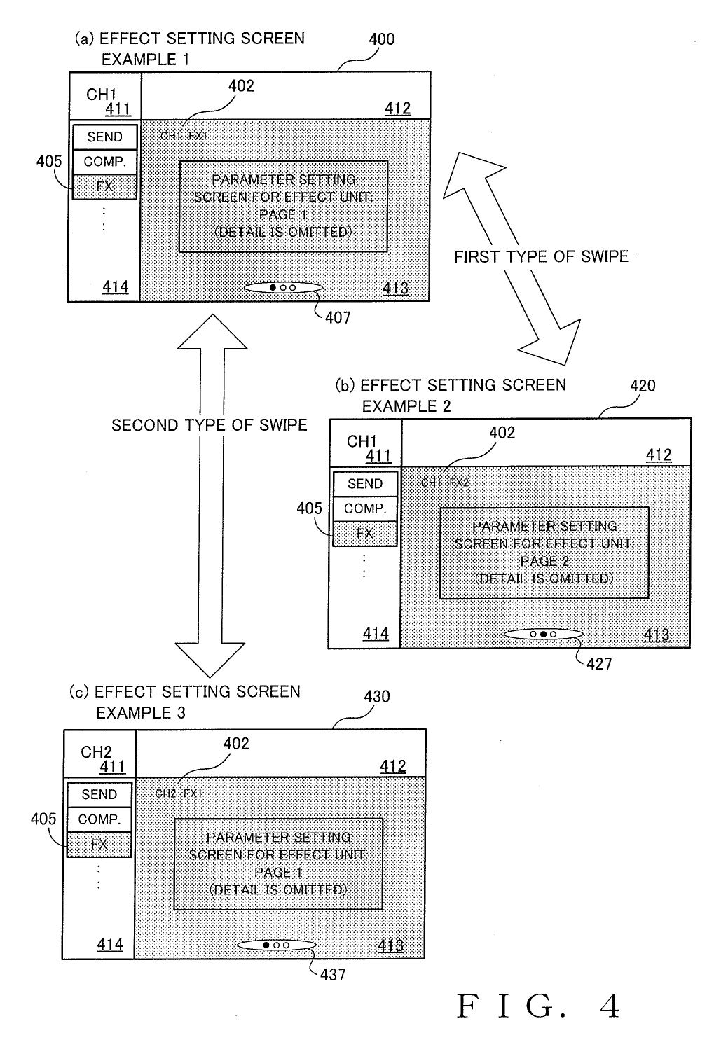

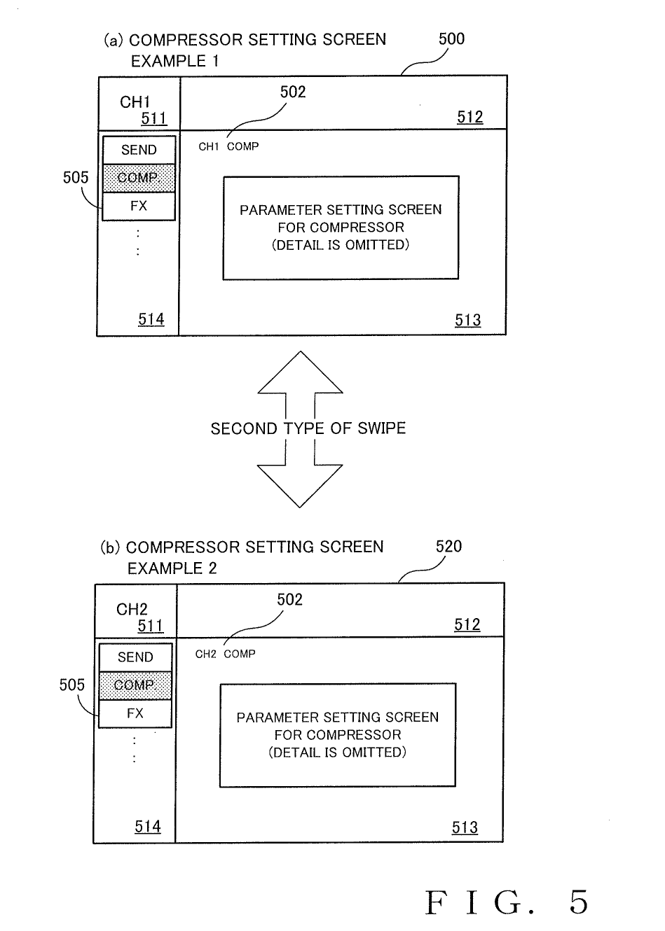

Part (a) of FIG. 4 is an effect setting screen example 1 (a setting screen 400) which is displayed in response to an FX (effect) button having been touched in the area 314 of the screen 300 in FIG. 3, for example. It should be noted that any setting screen can be switched to the effect setting screen by touching the FX button among the buttons, each of which specifies a kind of the parameters to be operated. In this case, the operation target channel remains the same as the operation target channel of the previous setting screen, and only the kind of parameters to be operated is changed. For example, this setting screen 400 can be regarded as the first user interface screen.

In the effect setting screen 400, area 411 is an area which displays the same channel number of the operation target channel as the area 311 in FIG. 3 Area 412 is an area that displays the menu, the tab, etc. for switching the function like the area 312 in FIG. 3. Area 414 is an area which displays the buttons, each of which specifies the kind of parameters to be set for the operation target channel. FIG. 4 shows that the FX button 405 is selected and that the parameter setting for an effector (namely, effect unit or effect imparting unit) of the operation target channel 1 is currently being performed. Area 413 is a partial screen which corresponds to the area 313 in FIG. 3, and various objects for the parameter setting for the effector are displayed in the area 413 (displayed images are not depicted). A reference numeral 402 denotes a displayed image of a title indicating that this screen is the effect setting screen of the channel 1. A reference numeral 407 denotes a displayed image for indicating a position of the page currently displayed in the area 413. The first page is displayed in this drawing, and thus a circle on the left end of the displayed image 407 is depicted as a black circle.

The first-type-of-swipe-valid area in the screen 400 in the part (a) of FIG. 4 is the area 413 which is depicted by shaded area. In each of the screen examples exemplified in FIG. 4, a shape (size) of the first-type-of-swipe-valid area differs from the screen examples exemplified in FIG. 3. Just as described, the shape of the first-type-of-swipe-valid area can be changed according to each of different kinds of parameters to be set. When the first type of swipe operation from the right to the left is performed in this area 413, the display is updated from the setting screen 400 as shown in the part (a) of FIG. 4 to a screen example 2 (a setting screen 420) as shown in a part (b) of FIG. 4. In this setting screen 420, the areas 411, 412, 414 are the same as those areas in the setting screen 400. Only in the area 413, the page is flipped to display images of parameters different from the parameters exemplified in the part (a) of FIG. 4, and the second page is displayed on the setting screen 420. The display is updated to the second page, and thus a display 427 of the page position is updated. For example, this setting screen 420 can be regarded as the second user interface screen.

Similarly to the aforementioned description referring to FIG. 3, even when the first type of swipe operation is performed in any of the areas 411, 412, 414, the mixer does not perform the page display processing which corresponds to the first type of swipe operation. Similar to the screen 400, the area 413 is the first-type-of-swipe-valid area in the screen example 420 in the part (b) of FIG. 4, and thus the page can further be flipped or flipped back by performing the first type of swipe operation in this area 413.

When the second type of swipe operation is performed at any position on the setting screen 400 of the part (a) of FIG. 4, the display is updated to a screen example 3 (a setting screen 430) as shown in the part (c) of FIG. 4. As aforementioned, the second type of swipe operation means the operation for switching the operation target channel. Thus, on the setting screen 430, the operation target channel which is displayed in the area 411 is changed to the channel of the channel number 2. New parameters regarding the changed channel are displayed on a partial screen in area 413 in stead of previously displayed parameters. For example, this setting screen 430 can be regarded as the third user interface screen.

Part (a) of FIG. 5 is a compressor setting screen example 1 (a setting screen 500) which is displayed when a COMP (compressor) button is touched in the area 314 of the screen 300 in FIG. 3, for example. An arbitrary setting screen can be switched to the compressor setting screen by touching the COMP button among the buttons, each of which specifies a kind of parameters to be operated. In this case, the operation target channel remains the same as the operation target channel of the previous setting screen, and only the kind of parameters to be operated is changed. For example, this setting screen 500 can be regarded as the first user interface screen.

In the compressor setting screen 500, area 511 is an area which displays the same channel number of the operation target channel as the area 311 in FIG. 3. Area 512 is an area which displays the menu, the tab, etc. for switching the function like the area 312 in FIG. 3. Area 514 is an area which displays buttons, each of which specifies the kind of parameters to be set for the operation target channel. FIG. 5 shows that a COMP button 505 is selected and that the parameter setting for the compressor of the channel number 1 as the operation target is currently being performed. Area 513 is a partial screen which corresponds to the area 313 in FIG. 3, and various objects for the parameter setting for the compressor are displayed in the area 513 (displayed images are not depicted). 502 denotes a title for indicating that this screen is the compressor setting screen of the channel of the channel number 1.

There is no first-type-of-swipe-valid area available in the screen 500 shown in the part (a) of FIG. 5. The first-type-of-swipe-valid area is not provided depending on, for example, the kind of parameters to be set. In addition, this means that there is only one page of the partial screen displayed in the area 513. Because there is no first-type-of-swipe-valid area, the page display processing is not performed even if the first type of swipe operation is performed in any area on the screen 500. In other words, in the example of FIG. 5, there is no second user interface screen to which the first user interface screen should be switched in accordance with the first type of swipe operation.

When the second type of swipe operation is performed at any position on the screen 500 of the part (a) of FIG. 5, the display is updated to a screen example 2 (a setting screen 520) as shown in the part (b) of FIG. 5. Although it is repeatedly described, the second type of swipe operation means the operation for switching the operation target channel. Thus, in the screen example 520, the operation target channel in the area 511 is switched from the channel of the channel number 1 to the channel of the channel number 2. On the partial screen in the area 513, parameters regarding the channel of the channel number 2 are displayed. For example, this setting screen 520 can be regarded as the third user interface screen to which the first user interface screen should be switched in accordance with the second type of swipe operation.

While the parameter setting screens for the send level, the effector and the compressor have been described so far, other parameter setting screens similar thereto can be applied to other kinds of parameters.

In summary, the user interface screen displayed on the display panel is associated with one of different kinds of user interface screens, and the user interface screen displayed on the display panel is identified by the combination taking account of the kind. In addition, for example, as it is seen in a difference between the area 313-1 shown in FIG. 3 and the area 413 shown in FIG. 4, in the user interface screen displayed on the display panel, the area in which the first type of swipe operation is valid is defined as an area unique to the kind identifying the user interface screen. Furthermore, for example, as it is seen in the example of FIG. 5, regarding a particular kind of the user interface screen, the area in which the first type of swipe operation is valid is not provided.

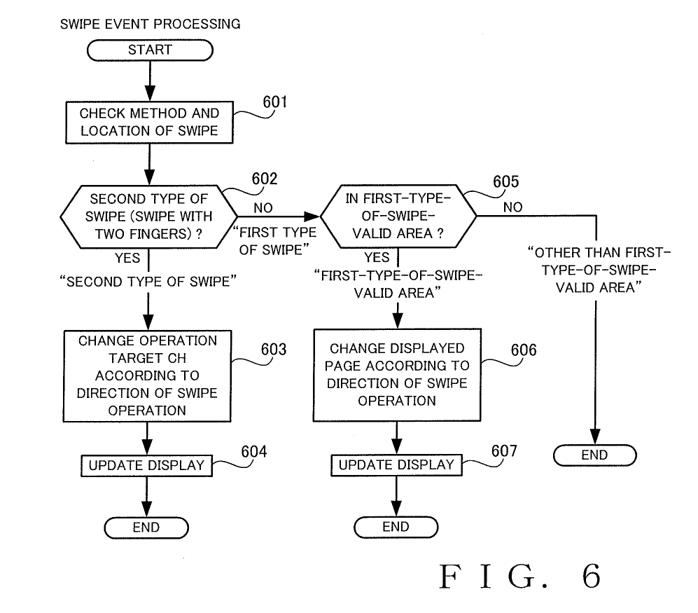

FIG. 6 is a flowchart of swipe event processing performed by the CPU 201. This processing is performed when the display device 203 detects that any type of the swipe operation is performed. In step 601, a type of the swipe operation (whether the first type of swipe operation or the second type of swipe operation) and a location where the swipe operation is performed are checked. In step 602, it is determined whether the swipe operation is the second type of swipe operation or not. If it is the second type of swipe operation, the channel number of the channel as the operation target is changed in accordance with a direction of the swipe operation in step 603. Then, in step 604, the display is updated to the content which corresponds to the changed channel number. In this embodiment, processing at step 603 is the processing in which, when the second type of swipe operation is performed from the right to the left on the screen, the channel number of the operation target is increased by one (the channel of the increased channel number is set as the operation target) and in which, when the second type of swipe operation is performed in a reverse direction, the channel number of the operation target is reduced by one (the channel of the reduced channel number is set as the operation target). It should be noted that, when flicking (an operation by rapid or snapping movement of a finger on the touch panel) is performed, the channel number may be increased or reduced by two or more in accordance with a detected moving speed of the finger. In the present embodiment, swipe is defined in a broader sense and includes the so-called flicking operation as well as the first and second types of swipe operation.

If it is determined that the swipe operation is not the second type of swipe operation, at step 602, the performed swipe operation is the first type of swipe operation, in this embodiment. Then, it is determined in step 605 whether the operation is performed in the first-type-of-swipe-valid area. If the first type of swipe operation which is detected and determined is the swipe operation in the first-type-of-swipe-valid area, the page of the partial screen displayed in the first-type-of-swipe-valid area is changed in accordance with the swiping direction, at step 606 (i.e., the page to be displayed is switched in this embodiment), and the display is updated at step 607. Processing at step 606 is processing in which, for example, when the first type of swipe operation is performed from the right to the left on the screen, the page of the partial screen displayed in the first-type-of-swipe-valid area is flipped forward (for example, the displayed content is switched from the content as shown in the part 8a) of FIG. 3 to the content as shown in the part (b) of FIG. 3) and in which, when the first type of swipe operation is performed in the reverse direction, the page is flipped back (for example, the displayed content is switched from the content as shown in the part (b) of FIG. 3 to the content as shown in the part (a) of FIG. 3). It should be noted that, when the flicking is performed, similar to the above, the number of the page to be flipped may be adjusted in accordance with a detected operational speed (for example, when the flicking operation is performed in a situation where the first page is displayed, the displayed page is updated to two pages ahead or more to switch the display). If it is determined in step 605 that the swipe operation is not performed in the first-type-of-swipe-valid area, the processing is terminated without performing any more processing. The program shown in FIG. 6 is an example of a program module for realizing the function of the display update section 103 shown in FIG. 1.

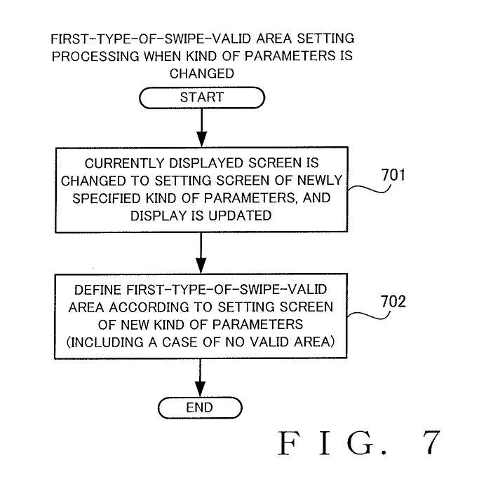

FIG. 7 is a flowchart of first-type-of-swipe-valid area setting processing which is performed by the CPU 201 when the kind of parameters is changed. This processing is performed when any of the buttons displayed in the areas 314, 414, 514 of the setting screens described with reference to FIG. 3 to FIG. 5 is touched to specify the kind of parameters. In step 701, the currently displayed screen is changed to the setting screen of the newly specified kind of parameters, and the display is updated. In step 702, a first-type-of-swipe-valid area is defined in accordance with the setting screen of the new specified kind of parameters. As exemplified in FIG. 5, a definition of not providing the first-type-of-swipe-valid area may be possible. For example, processing for defining the first-type-of-swipe-valid area may be performed as follows. An area to be used for the first-type-of-swipe-valid area is predefined for each kind of parameters, and information of such the predefined areas are prestored in the memory 202. The information of an area corresponding to the newly specified kind of parameters is read out from the memory 202 and then a necessary setting screen including a first-type-of-swipe-valid area as defined by the read-out information is depicted on the display device 203 by processing at steps 701 to 702. The program shown in FIG. 7 is an example of a program module for realizing the function of the area setting section 102 shown in FIG. 1.

In the aforementioned embodiment, a display mode in which the page is flipped in response to the first type of swipe operation performed on each of the setting screens has been described. However, display for showing a change of pages may be presented in such a manner that brings a suitable visual paging effect such as scrolling.

In the above embodiment, displayed content of the partial screen corresponding to the first-type-of-swipe-valid area is changed on the display screen in response to the first type of swipe operation, and other displayed content of the other part of the screen is not changed. However, it may be configured that, when the first type of swipe operation is performed in the first-type-of-swipe-valid area, the displayed content of the other part than the first-type-of-swipe-valid area is changed. For example, if the first type of swipe operation is repeated in the first-type-of-swipe-valid area 313-1 shown in the part (a) of FIG. 3 until the last page of the mixing buses is displayed, and thereafter further first type of swipe operation is performed, then the page is moved to the first page of the channel as the next operation target (for example, the channel of the channel number 2 in the case where the send level setting screen for the channel of the channel number 1 is displayed). In addition, similarly to the aforementioned embodiment, when the flicking operation is performed, the display screen may further be moved to the display screen for another channel as a further next operation target.

Operation ways of the first and second types of swipe operation are not limited to those described in the above embodiment. For example, the first and second types of swipe operation may be distinguished from each other by a difference in the number of touched fingers other than one finger or two fingers (three fingers or more), a difference in touch intensity, a difference in a contact area of the finger, a difference in a moving direction of the finger (for example, vertical and horizontal, or further another direction), a difference in displacement of the finger, a difference in touch duration (long touch duration), or the like. Furthermore, the first and second types of swipe operation may be distinguished from each other by performing the swipe operation while another object or physical control is operated or while the other object or physical control is not operated.

In the above embodiment, only two ways of swipe operation are raised for examples. However, the number of the swipe operation ways is not limited to two. Further, two of many swipe operation ways may be selected to determine as the first and second types of swipe operation. The area in which the second type of swipe operation is valid is set as the entire area of the screen in the above embodiment. However, only a part of the entire area may be used for an area in which the second type of swipe operation is valid.

In the above embodiment, the channel as the operation target is switched by the second type of swipe operation, and the page of the parameter as the operation element is switched by the first type of swipe operation. However, the operation target and/or the operation element to be switched are not limited to the channel and/or parameter. For example, whereas the first type of swipe operation causes the page of the operation element to be switched to another in the aforementioned embodiment, the first type of swipe operation may cause the kind of the operation element to be switched to another in another embodiment; the kind of the operation element may correspond to any of the buttons shown in the display area 314 in FIG. 3 (namely, one kind of setting screens as shown in FIG. 3, FIG. 4, FIG. 5 may be switched to another kind in response to the first type of swipe operation). In addition, the operation target is not limited to the channels. The operation target may be any processing unit, functional unit, or the like which has a group of the same type of parameters like the channel.

In the aforementioned embodiment, it is assumed that the touch panel associated with the display panel of the display device 203 is incorporated into the display panel in such a manner as to overlap with each other. However, in an alternative embodiment according the present invention, a track pad or the like capable of multi-touch detection may be used as the touch panel for detecting at least two types of swipe operation. In that case, the touch panel, namely the track pad or the like, may be provided separately from the display panel but associated with the display panel so as to be able to control a cursor or the like displayed on the display panel by means of a user's touch operation on the touch panel.

This application is based on, and claims priority to, JP PA 2014-049490 filed on 12 Mar. 2014. The disclosure of the priority application, in its entirety, including the drawings, claims, and the specification thereof, are incorporated herein by reference.

1. A display control apparatus comprising:
a display device configured to detect a touch operation performed by a user on a touch panel associated with a display panel, the display device being adapted to detect at least a first type of swipe operation and a second type of swipe operation different from the first type of swipe operation, and a user interface screen displayed on the display panel being identified by a combination of one of operation targets and a group of operation elements;
an area setting section configured to define an area on the user interface screen displayed on the display panel where the first type of swipe operation is valid; and
a display update section configured to update the user interface screen displayed on the display panel in such a manner that, (1) when the first type of swipe operation is detected in the defined area on a first user interface screen which is identified by a combination of a first operation target and a first group of operation elements, the first user interface screen is changed to a second user interface screen which is identified by a combination of the first operation target and a second group of operation elements, whereas, (2) when the second type of swipe operation is detected on the first or second user interface screen, the first or second user interface screen is changed to a third user interface screen which is identified at least by a second operation target.

2. The display control apparatus according to claim 1, wherein when the first type of swipe operation is detected in the area of the first user interface screen, the display update section changes the first user interface screen to the second user interface screen by replacing a partial screen corresponding to the area of the first user interface screen with another partial screen corresponding to the second group.

3. The display control apparatus according to claim 1, wherein the user interface screen displayed on the display panel is associated with one of different kinds of user interface screens, and
wherein the user interface screen displayed on the display panel is identified by the combination taking account of the kind.

4. The display control apparatus according to claim 3, wherein the area setting section is configured to define the area on the user interface screen displayed on the display panel in which the first type of swipe operation is valid, as an area unique to the kind identifying the user interface screen.

5. The display control apparatus according to claim 4, wherein the area setting section is configured to provide no area, in which the first type of swipe operation is valid, regarding a particular type of a user interface screen.

6. The display control apparatus according to claim 1, wherein the first type of swipe operation and the second type of swipe operation are distinguished based on a difference in the number of fingers with which the swipe operation is performed.

7. The display control apparatus according to claim 1, wherein one group of the operation elements is displayed in an image of one page in the area of the user interface screen, and
wherein the display update section changes the first user interface screen to the second user interface screen by switching a page to be displayed in the area in response to detection of the first type of swipe operation in the area.

8. The display control apparatus according to claim 1, wherein each of the operation elements comprises a control for setting a parameter.

9. The display control apparatus according to claim 1, which is a display control apparatus for a mixer,
wherein the operation targets are channels for signal processing in the mixer, and
wherein the operation elements are operation elements for one of the channels which is selected as a current operation target in the mixer.

10. The display control apparatus according to claim 9, wherein the operation elements are send levels for a plurality of mixing buses in the mixer.

11. The display control apparatus according to claim 9, wherein the user interface screen displayed on the display panel is associated with one of different types of user interface screens,
wherein the user interface screen displayed on the display panel is identified by the combination taking account of the type, and
wherein the different types of user interface screens are associated with different types of parameters which can be set in the mixer.

12. A computer-implemented method for controlling display, comprising:
detecting a touch operation performed by a user on a touch panel associated with a display panel of a display device, the display device being adapted to detect at least a first type of swipe operation and a second type of swipe operation different from the first type of swipe operation, a user interface screen displayed on the display panel being identified by a combination of one of operation targets and a group of operation elements;
defining an area on the user interface screen displayed on the display panel where the first type of swipe operation is valid; and
updating the user interface screen displayed on the display panel in such a manner that, (1) when the first type of swipe operation is detected in the defined area on a first user interface screen which is identified by a combination of a first operation target and a first group of operation elements, the first user interface screen is changed to a second user interface screen which is identified by a combination of the first operation target and a second group of operation elements, whereas, (2) when the second type of swipe operation is detected on the first or second user interface screen, the first or second user interface screen is changed to a third user interface screen which is identified at least by a second operation target.

13. A non-transitory computer-readable medium containing a group of instructions executable by a processor to perform a method for controlling display, the method comprising:
detecting a touch operation performed by a user on a touch panel associated with a display panel of a display device, the display device being adapted to detect at least a first type of swipe operation and a second type of swipe operation different from the first type of swipe operation, a user interface screen displayed on the display panel being identified by a combination of one of operation targets and a group of operation elements;
defining an area on the user interface screen displayed on the display panel where the first type of swipe operation is valid; and
updating the user interface screen displayed on the display panel in such a manner that, (1) when the first type of swipe operation is detected in the defined area on a first user interface screen which is identified by a combination of a first operation target and a first group of operation elements, the first user interface screen is changed to a second user interface screen which is identified by a combination of the first operation target and a second group of operation elements, whereas, (2) when the second type of swipe operation is detected on the first or second user interface screen, the first or second user interface screen is changed to a third user interface screen which is identified at least by a second operation target.
